(19) United States
(12) Patent Application Publication
(10) Pub. No.: US 2012/0145748 A1
(43) Pub. Date: Jun. 14, 2012

(54) ONE-TOUCH-TYPE GEL CONTAINER HAVING AUTOMATIC SEALING STRUCTURE

(75) Inventor: Hyun-Son Yoon, Incheon (KR)

(73) Assignee: Morris Corporation, Incheon-si (KR)

(21) Appl. No.: 12/980,020

(22) Filed: Dec. 28, 2010

(30) Foreign Application Priority Data
Dec. 10, 2010 (KR) 10-2010-0126472

(51) Int. Cl. B67D 7/58

(52) U.S. Cl. 222/390; 222/514

(57) ABSTRACT

Disclosed herein is a one-touch-type gel container having an automatic sealing structure, which allows cosmetic ingredients to be preserved for a longer period of time, minimizes the volatilization of the cosmetic ingredients, and enables a desired amount of liquid ingredients to be used. As a screw lever is pushed, a locking protrusion of a cartridge moving along with the screw lever is removed from a second locking hole and is restrained by a first locking hole, so that a nozzle is ejected from a nozzle hole. As the area of the screw lever exposed to the outside of rotary lever holes of a barrel and the cartridge m reaches a maximum, the piston fastened to the screw lever in a threaded manner moves forwards when the screw lever is rotated, so that contents are pushed from the cartridge and are discharged through a contents moving part to the nozzle.

### PRIORITY

This application claims priority under 35 U.S.C. §119(a) to an application filed in the Korean Intellectual Property Office on Dec. 10, 2010 and assigned Korean Patent Application No. 10-2010-0126472, the contents of which are incorporated herein by reference.

### BACKGROUND OF THE INVENTION

1. Field of the Invention

The present invention relates generally to a one-touch-type gel container having an automatic sealing structure and, more particularly, to a one-touch-type gel container having an automatic sealing structure, which is constructed so that a liquid type gel pushed out from a cartridge by a piston is discharged only when a shutter of a discharge port is open.

2. Description of the Related Art

In order to prevent cosmetic contents from volatilizing and decomposing and provide a good state of preservation, a cosmetic container must be isolated from the outside and the cosmetic container must be airtight.

To this end, a container constructed so that a nozzle for discharging cosmetics can be ejected or retracted has been proposed. The container is advantageous in that it is unnecessary to open or close an additional cap, thus making it convenient to use. However, the container is disadvantageous in that a nozzle hole through which the nozzle is ejected or retracted is simply bored in an end of the container, so that the container may be limitedly applied to only nonvolatile substances.

Meanwhile, as for highly volatile liquid cosmetics, apart from the inconvenience of opening and closing a cap, when a container is exposed to the air for a lengthy period of time with the nozzle open, gel of the nozzle dries, so that the lifespan of the container may be reduced, and ingredients of the cosmetics decompose, so that the performance of the cosmetics may be deteriorated.

+Thus, a lot of research has been made into a container for containing liquid or semi-liquid or volatile or nonvolatile cosmetics that can prevent the cosmetics from drying out and protect a nozzle.

For example, Korean U.M. Application. No. 20-2009-0001610 has been proposed, which is entitled ‘Makeup Tool With Dry Prevention Cap’. The makeup tool is constructed so that the dry prevention cap is provided on an opening of a casing, so that the cap closes the opening of the casing when the makeup tool is not in use, and a push button provided on the upper end of the casing is pressed with one hand when the makeup tool is in use, so that the cap is rotated and an application means such as a brush is ejected out of the casing. Such a makeup tool may be manipulated with one hand.

However, this is only a casing for protecting a brush or the like, and its application to air-tightly contain liquid type cosmetics and the use of the nozzle in a retractable manner are limited.

### SUMMARY OF THE INVENTION

Accordingly, the present invention has been made keeping in mind the above problems occurring in the prior art, and an object of the present invention is to provide a one-touch-type gel container having an automatic sealing structure, which includes an anti-drying unit so that a nozzle retractably protrudes in a non-contact manner while maintaining air tightness, prevents liquid ingredients from drying out at the nozzle even though an additional cap is not used, enables the nozzle to be protected physically safely, and affords convenient use.

Another object of the present invention is to provide a one-touch-type gel container having an automatic sealing structure, a piston of which is intended to discharge a predetermined amount of liquid ingredients from a cartridge.

In order to accomplish the above objects, the present invention provides a one-touch-type gel container having an automatic sealing structure, including a barrel comprising an integrated casing having a shape of a hollow pipe and including a nozzle hole formed in a first conical end of the barrel to permit a nozzle to be ejected or retracted, and an insert hole formed in a second end of the barrel; a cartridge inserted into the barrel, and moving forwards and backwards in a longitudinal direction of the barrel; a screw lever having a shape of a pipe which is open at an end, the screw lever being restrained at an end thereof by a step of a tank part of the cartridge to be rotated without forward or backward movement in the tank part; a piston accommodated in the screw lever, a first end of the piston being connected to a contents moving part which has a diameter that is set to be accommodated in the cartridge, a second end of the piston having a shape corresponding to the screw lever to engage with an inner wall of the screw lever; and an anti-drying unit interposed between the cartridge and the barrel to air-tightly close the nozzle hole of the barrel in conjunction with forward or backward movement of the cartridge which is moved integrally with the screw lever.

Further, the barrel may include a first and a second locking holes arranged in a longitudinal direction on a side of an elliptical rotary lever hole which is formed adjacent to the second end of the barrel, and the cartridge may include a locking protrusion protruding from a side surface of the tank part to be removably restrained by the first or second locking hole, and a rotary lever hole formed on a side of the locking protrusion to have the same shape and position as the rotary lever hole of the barrel.

Further, the locking protrusion may be formed on a sidewall of the cartridge in the form of an elastic free end such that the locking protrusion can be easily removably restrained by the first locking hole or by the second locking hole.

Further, the barrel may further include a return switch extending from a location in front of the first locking hole in the form of a free end so as to allow the locking protrusion to be easily removed from the first locking hole, the return switch when pushed by a hand being bent into the barrel to make the locking protrusion restrained by the first locking hole be bent into the cartridge, thus removing the locking protrusion from the first locking hole.

Further, the return switch may have a protruding push part so that the return switch can be easily pushed.

Further, a guide protrusion having a form of a free end may be formed at a position opposite to the locking protrusion of the cartridge, and the barrel may include a guide hole at a position corresponding to the guide protrusion so that the guide protrusion is inserted into and restrained by the guide hole, thus guiding the cartridge to perform rectilinear movement when the cartridge moves forwards and backwards in the longitudinal direction of the barrel.

Further, the cartridge may include a tension groove to define a space to permit the free end to be bent into the cartridge.

Further, the cartridge may include a tank part having a largest diameter, a first portion of the tank part receiving contents and a second portion thereof receiving the screw lever; a connection part having a diameter smaller than that of the tank part, a first portion of the connection part receiving the contents and a second portion thereof receiving the contents moving part; and an extension part having a diameter smaller than that of the connection part, and firmly coupled at an end thereof to the nozzle.

Further, an O-ring may be provided at a junction between the piston and the contents moving part in such a way as to be in close contact with an inner wall of the cartridge, thus preventing contents from remaining in the cartridge when the piston moves forwards.

Further, the screw lever may include at the second end thereof an air circulating hole to permit flow of air in a space defined by movement of the piston.

Further, a groove formed on an inner wall of the connection part in the longitudinal direction of the barrel may engage with a cross-shaped step of the contents moving part, and an internal thread formed on the inner wall of the screw lever may engage with an external thread formed on the piston, so that the piston conducts only rectilinear movement when the screw lever is rotated.

Further, an internal thread formed on an inner wall of the connection part may engage with an external thread formed on the contents moving part, and a rib provided on the inner wall of the screw lever in a longitudinal direction thereof may engage with a rib provided on the piston in a longitudinal direction thereof, so that the piston conducts rectilinear movement and rotation when the screw lever is rotated.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a conventional makeup tool having a dry prevention cap;

FIG. 2 is an exploded perspective view showing a one-touch-type gel container having an automatic sealing structure, according to the present invention;

FIG. 3 is a perspective view showing a barrel included in the container of FIG. 2;

FIG. 4 is a perspective view showing a cartridge included in the container of FIG. 2;

FIG. 5 is a sectional view showing a screw lever included in the container of FIG. 2;

FIG. 6 is a side view showing the one-touch-type gel container having the automatic sealing structure according to the present invention, in the closed state;

FIG. 7 is a sectional view corresponding to FIG. 6;

FIG. 8 is a front view showing the one-touch-type gel container according to the present invention, in the closed state;

FIG. 9 is a sectional view corresponding to FIG. 8;

FIG. 10 is a side view showing the one-touch-type gel container having the automatic sealing structure according to the present invention, in the open state;

FIG. 11 is a sectional view corresponding to FIG. 10;

FIG. 12 is a front view showing the one-touch-type gel container according to the present invention, in the open state; and

FIG. 13 is a sectional view corresponding to FIG. 12.

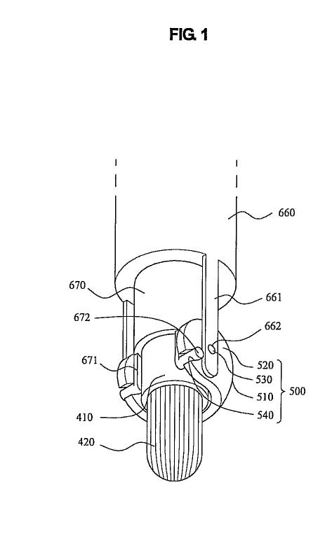

### DESCRIPTION OF THE PREFERRED EMBODIMENTS

Hereinafter, a one-touch-type gel container having an automatic sealing structure according to an embodiment of the present invention will be described in detail with reference to the accompanying drawings.

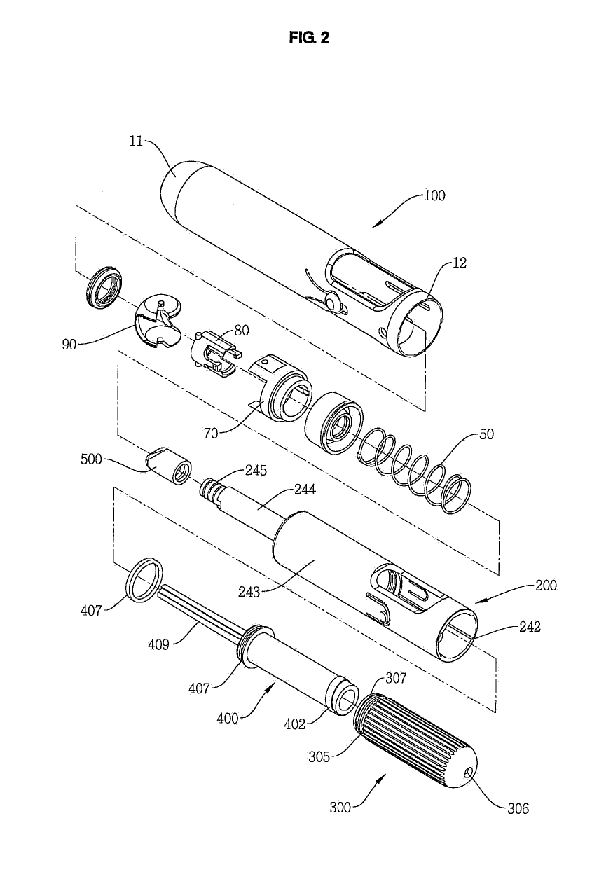

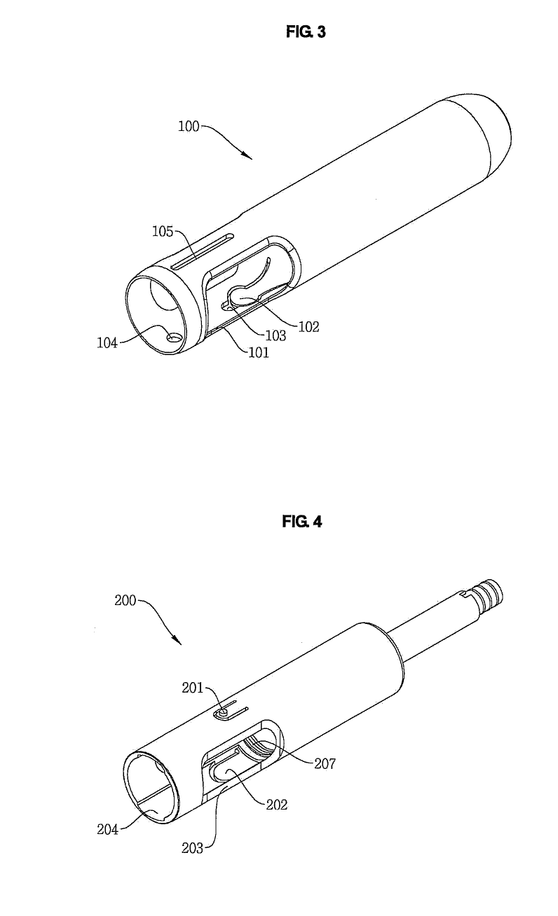

FIG. 2 is an exploded perspective view showing a one-touch-type gel container having an automatic sealing structure according to the present invention, and FIG. 3 is a perspective view showing a barrel included in the container of FIG. 2.

Further, FIG. 4 is a perspective view showing a cartridge included in the container of FIG. 2, and FIG. 5 is a sectional view showing a screw lever included in the container of FIG. 2.

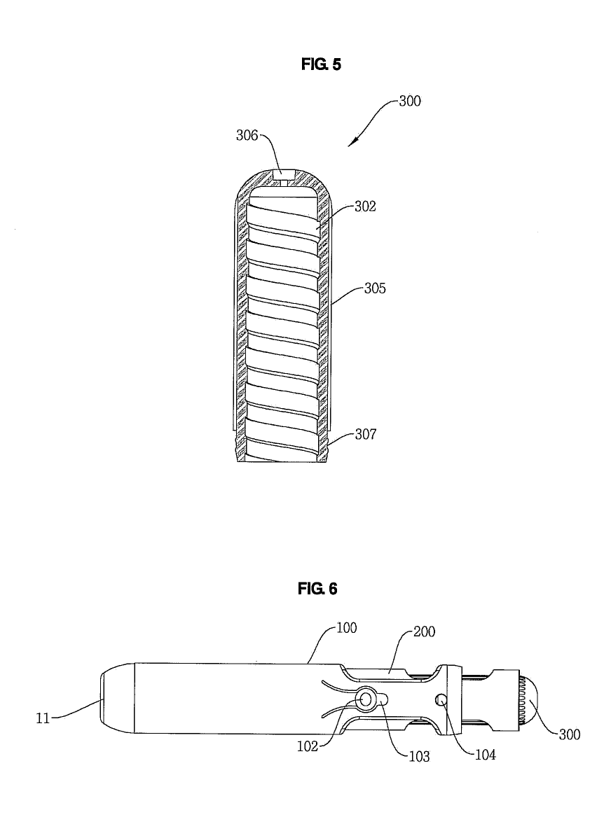

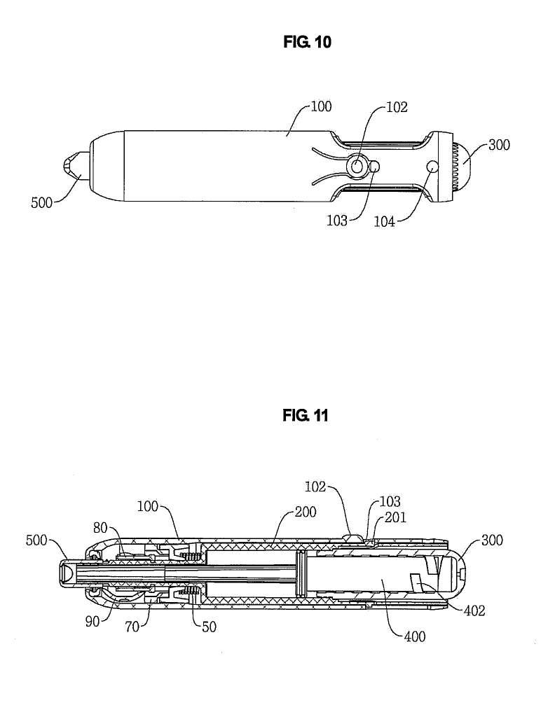

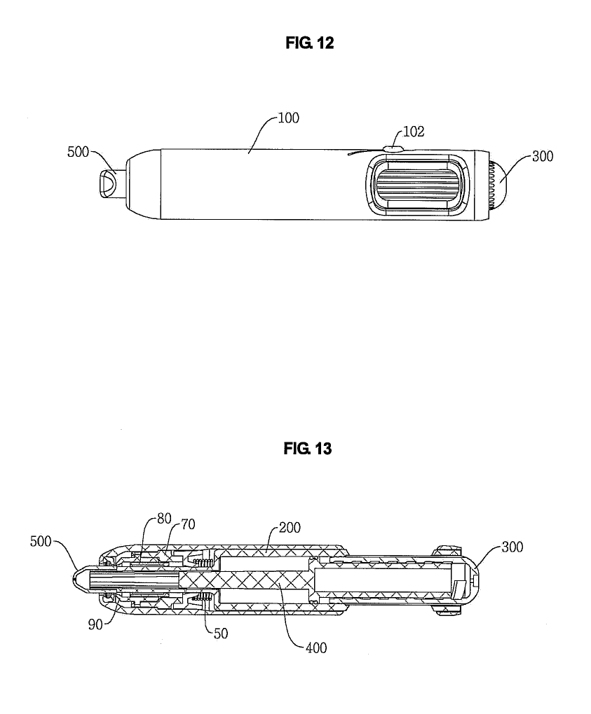

Further, FIGS. 6 to 9 are views showing the one-touch-type gel container having the automatic sealing structure according to the present invention, in the closed state, and FIGS. 10 to 13 are views showing the one-touch-type gel container having the automatic sealing structure according to the present invention, in the open state.

As shown in FIG. 2, a one-touch-type gel container of the present invention includes a barrel 100, a cartridge 200, a screw lever 300, a piston 400, a nozzle 500, and an anti-drying unit for opening or closing a discharge port.

The anti-drying unit includes a spring 50, an O-ring 60, a holder 70, a link 80, a ball-type door 90, and packings interposed between the components. The anti-drying unit has the same construction as a device for air-tightly closing a nozzle hole of a barrel, which is disclosed in Korean Patent No. 10-0817202 that was filed by the inventor of the present invention and is entitled ‘a retractable writing instrument having an anti-drying unit’. The detailed description of the construction and mechanism of the device will be omitted herein.

The anti-drying unit functions to rotate the ball-type door 90, which is seated in the barrel 100 in such a way that parallel pins 82 of the link 80 are fitted into pin slits 92, by a predetermined angle in conjunction with the slidable rectilinear reciprocating motion of the link 80, by the interaction between the cartridge 20, the spring 50, the O-ring 60, the holder 70, and the link 80, thus opening or closing the ball-type door 90. Here, the cartridge 200 is inserted into the barrel 100. The spring 50 serves to restore the cartridge 200 to its original position using elastic force. The O-ring 60 is provided in the barrel 100 to perform an airtight sealing operation while allowing axial movement of the cartridge 20. The holder 70 is seated in the barrel 100 in such a way that a first end of the holder 70 is axially inserted into the O-ring 60. The link 80 is slidably provided in the holder 70.

That is, the anti-drying unit of the present invention is operated as follows. When a user holds the barrel 100 with one hand and then pushes the screw lever 300, corresponding to a push part provided on the upper end of the container, with the thumb or the like, the ball-type door 90 operated in conjunction with the screw lever 300 and the cartridge 200 is rotated in an opening direction by the rotating angle of +90°. Thereby, a passage of the ball-type door 90 is aligned with the axial direction of the nozzle 500, and simultaneously a nozzle hole 11 of the barrel 100 is opened.

Subsequently, the nozzle 500 is ejected out of the nozzle hole 11 through the passage of the ball-type door 90, so that the container is ready to be used.

In contrast, when a user pushes a return switch, the cartridge 200 is removed from the barrel 100 by the return switch, and the ball-type door 90 is rotated in a closing direction by the rotating angle of −90° by the elastic restoring force of the spring 50. Thereby, the passage is perpendicular to the axial direction of the nozzle 500, and simultaneously the nozzle hole 11 of the barrel 100 is closed. The ejected nozzle 500 is restored to its original position, namely, retracted into the barrel 100.

Here, the direction in which the nozzle 500 is ejected is designated as the forward moving direction, while the opposite direction is designated as the backward moving direction.

Further, a side of the barrel 100 having the nozzle hole 11 is designated as a front portion, while an opposite side is designated as a rear portion.

As shown in FIGS. 2 and 3, the barrel 100 is an integrated casing, and has the shape of a hollow pipe or tube.

The barrel 100 may be produced by an injection molding process, such as a molding process using a plastic material. When the barrel 100 is made of the plastic material, the barrel 100 has one of the general properties of plastics, namely, elasticity, flexibility and extendibility.

The nozzle hole 11 is formed in a conical first end of the barrel 100, and an insert hole 12 is formed in a second end of the barrel 100 and has an inner diameter that is big enough for the following components to be inserted into the barrel 100.

A pair of rotary lever holes 101, each having an elliptical shape, is formed in both sides of the second end of the barrel 100.

The rotary lever holes 101 are open such that the cartridge 200 and the screw lever 300 are exposed to the outside when the cartridge 200 and the screw lever 300 that will be described below in detail are inserted into the barrel 100. Especially in the state in which the screw lever 300 is restrained in the barrel 100, the screw lever 300 is rotatable on the rotary lever holes 101.

The return switch 102 and first and second locking holes 103 and 104 are provided on a first side of the rotary lever hole 101, while a guide hole 105 is formed in a second side of the rotary lever hole 101.

The first and second locking holes 103 and 104 are formed such that a locking protrusion 201 of the cartridge 200 which will be described below is restrained by either the first or second locking hole 103 or 104, when the cartridge 200 moves forwards or backwards.

That is, the second locking hole 104 is formed in the second end of the barrel 100 so that the locking protrusion 201 is inserted into the second locking hole 104 when the cartridge 200 moves backwards. The first locking hole 103 is formed in front of the second locking hole 104 in the same line as the second locking hole 104 so that the locking protrusion 201 is inserted into the first locking hole 103 when the cartridge 200 moves forwards.

The return switch 102 is a free end that is formed in a side surface of the barrel 100 in such a way as to extend from a front end of the first locking hole 103.

Thus, the return switch 102 may be elastically bent inwards or outwards relative to the side surface of the barrel 100. Especially, as the return switch 102 is pushed, the return switch 102 is bent into the barrel 100 to release the locking protrusion, which is a free end having the same characteristics as the return switch 102, from the first locking hole 103.

Thus, it is preferable that the return switch 102 has a protruding push part on its outer surface so that the return switch 102 can be more easily pushed.

The guide hole 105 is placed opposite the return switch 102 and the locking holes 103 and 104.

The guide hole 105 is a hole that restrains a guide protrusion 202 of the cartridge 200 and guides the forward and backward movement of the cartridge 200.

To this end, the guide hole 105 is vertically formed in a longitudinal direction of the barrel 100.

As shown in FIGS. 2 and 4, the cartridge 200 includes a tank part 243, a connection part 244, and an extension part 245 which are integrated with each other so that diameters thereof are sequentially reduced in stages in a direction from a cartridge hole 242 to the nozzle 500. The tank part 243 has the largest diameter. The connection part 244 has a diameter relatively smaller than the tank part 243. The extension part 245 has a diameter relatively smaller than the connection part 244.

Further, a plurality of annular protrusions is formed on the outer surface of the extension part 245 and the inner surface of the nozzle 500, so that the annular protrusions engage with each other, thus allowing the cartridge 200 and the nozzle 500 to be more firmly coupled to each other and realizing a tighter state of sealing.

After the cartridge 200 is inserted into the insert hole 12 of the barrel 100, a user may axially reciprocate the cartridge 200 within a predetermined stroke range so that the nozzle 500 is ejected out of or retracted into the nozzle hole 11 of the barrel 100 according to the above-mentioned retractable mechanism, and a stop operation may be temporarily performed at either end of the stroke.

To this end, the locking protrusion 201 and the guide protrusion 202 are formed on the side surface of the cartridge 200.

The locking protrusion 201 is the free end having a protrusion, which is formed on the outer surface of the tank part 243 to be caught by the first locking hole 103 or the second locking hole 104 of the barrel 100 as the cartridge 200 moves linearly forwards or backwards.

That is, the locking protrusion 201 may also be bent elastically inwards or outwards relative to the side surface of the tank part 243, in a similar manner to the return switch 102. Especially if the return switch 102 pushes the locking protrusion 201 which is restrained by the first locking hole 103, the locking protrusion 201 is bent into the tank part 243 to be removed from the first locking hole 103.

Further, the guide protrusion 202 is provided to be opposite to the locking protrusion 201 in the form of the free end, and is restrained by the guide hole 105 to allow the cartridge 200 to move linearly forwards or backwards.

The tank part 243 also has a pair of rotary lever holes 203, similarly to the barrel 100 having the rotary lever holes 101.

Each rotary lever hole 203 has the same shape as the rotary lever hole 101 of the barrel 100 and is formed at the same position as the rotary lever hole 101, so that the rotary lever holes 101 and 203 overlap each other as the cartridge 200 moves forwards in the barrel 100.

Further, tension grooves 204 are formed in the inner surface of the tank part 243 at positions corresponding to the guide protrusion 202 and the locking protrusion 201 in such a way as to extend in the longitudinal direction of the tank part 243, thus providing a space that permits the free ends such as the guide protrusion 202 and the locking protrusion 201 to bend inwards in a sufficiently flexibly manner even if the screw lever 300 is accommodated in the tank part 243.

Further, the cartridge 200 contains gel-phased contents therein, and moves the contents through the connection part 244 to the nozzle 500 by the piston 400.

In detail, in order to supply contents to the tank part of the cartridge 200 from a front end of each rotary lever hole 203 of the tank part 243 to a front end of the tank part 243, a corrugated fitting end 207 formed around the front end of the rotary lever hole 203 of the tank part 243 water-tightly engages with a corrugated fitting end 307 of the screw lever 300.

A groove is formed in the inner wall of the connection part 244 in the longitudinal direction of the barrel 100, so that a step of a contents moving part 409 which will be described below is inserted into the groove. Thereby, the contents moving part 409 and the piston 400 integrally connected thereto may not be rotated but may linearly move along the screw lever 300.

Hereinafter, only an embodiment of the present invention wherein the piston 400 is fastened to the screw lever 300 in a threaded manner and is coupled to the connection part 244 using the groove and the step to perform only rectilinear movement is described. However, without being limited to the embodiment, the piston 400 may be coupled to the screw lever 300 using ribs and be coupled to the connection part 244 in a threaded manner so that the piston 400 performs rectilinear movement and rotation.

That is, in order to perform the rectilinear movement and rotation of the piston 400, ribs are formed on the piston 400 and ribs are also formed on the inner wall of the screw lever 300 to correspond to the ribs of the piston 400, so that the ribs engage with each other. Further, an external thread is provided on the contents moving part 409 and an internal thread is also provided on the inner wall of the connection part 244 so that the threads engage with each other. Thereby, when the screw lever 300 is turned, the piston 400 is rotated and moved forwards by the threads.

As shown in FIGS. 2 and 5, the screw lever 300 has the shape of a pipe or tube which is open at a first end thereof to be accommodated in the tank part 243 of the cartridge 200, and has, on an end of a piston inserting part 305 into which the piston 400 is inserted, a corrugated fitting end 307 that corresponds to the corrugated fitting end 207. When the screw lever 300 and the piston 400 constructed as described above are coupled to each other, the piston 400 may perform only rotation but not forward and backward movement.

The screw lever 300 has on its inner surface an internal thread 302, so that the internal thread 302 engage with an external thread formed on the piston 400 which will be described below, and thus the forward and backward movement of the piston 400 is caused by the rotation of the screw lever 300.

Further, an air circulating hole 306 is formed in a second end of the screw lever 300, so that a space occupied by the piston 400 in a hermetic space in the screw lever 300 serves as an air passage that permits the inflow and outflow of the air.

Since crimples are formed on the outer surface of the screw lever 300 in a longitudinal direction thereof, frictional force is increased when the screw lever 300 is rotated by the hand, and thus more efficient rotation of the screw lever 300 is achieved.

As shown in FIG. 2, the piston 400 is accommodated in the screw lever 300. An external thread 402 corresponding to the internal thread 302 is formed on an end of the piston 400 to engage with the internal thread 302 of the screw lever 300.

Further, the piston 400 is connected at an end thereof to the contents moving part 409 having a diameter which is proper to be accommodated in the connection part 244. When a corrugated O-ring 407 attached between the piston 400 and the contents moving part 409 moves forwards while being in close contact with the inner wall of the tank part 243, all of the gel-phased contents are discharged without remaining on the inner wall of the tank part 243.

The contents moving part 409 is a cross-shaped solid bar, and engages with the groove formed in the connection part 244, so that the contents moving part 409 and the piston 400 integrally connected to the contents moving part 409 do not rotate but are linearly moved when the screw lever 300 rotates.

Further, the contents moving part 409 allows the contents to move through a space between the contents moving part 409 and the groove of the connection part 244. Thus, the contents pushed by the piston 400 are supplied to the contents moving part 409 and then are transmitted through the connection part 244 to the nozzle 500.

The nozzle 500 has an annular protrusion which has a shape corresponding to the annular protrusion of the extension part 245 to be coupled to the annular protrusion thereof. The nozzle 500 is firmly coupled to the extension part 245 to discharge the gel-phased contents from the connection part 244 while maintaining water tightness.

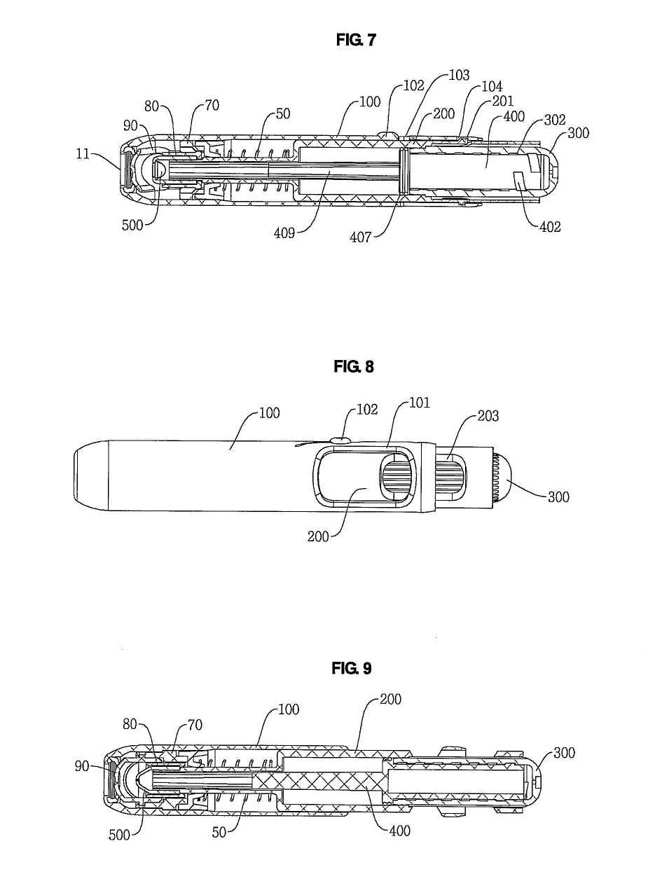

FIGS. 6 and 7 are a side view and a sectional view showing the container according to the present invention, in the closed state, and FIGS. 8 and 9 are a front view and a sectional view showing the container according to the present invention, in the closed state.

As shown in the drawings, the screw lever 300 engaging with the external thread of the piston 400 is inserted through the cartridge hole 242 into the cartridge 200, so that the contents moving part 409 is inserted into the connection part 244 and the corrugated fitting ends of the screw lever 300 and the tank part 243 engage with each other.

In the state in which the cartridge 200 is filled with the contents, an end of the piston 400 is in contact with the second end of the screw lever 300, that is, the air circulating hole 306.

Thus, the screw lever 300 rotates about an axial central line in the cartridge 200, and the piston 400 is rotated and moved forwards by the external thread engaging with the screw lever 300. Of course, the piston 400 may move forwards and then move backwards again. However, since the piston 400 functions to push the contents out from the cartridge 200, it is unnecessary to move the piston 400 backwards to flow the contents backwards.

Further, the nozzle 500 is fastened to the extension part 245 in a threaded manner to be firmly coupled thereto.

The spring 50, the holder 70, the link 80, and the ball-type door 90 of the anti-drying unit are sequentially placed from a step formed between the tank part 243 and the connection part 244 of the cartridge 200 for the pushing operation of the anti-drying unit.

The cartridge 200 containing the contents is accommodated in the barrel 100 through the insert hole 12 of the barrel 100.

Here, rubber packings are interposed between the holder 70 and the spring 50 and between the nozzle hole 11 of the barrel and the ball-type door 90 so as to increase water tightness between the above components.

Further, the locking protrusion 201 of the cartridge 200 is restrained by the second locking hole 104, and the guide protrusion 202 is restrained by the guide hole 105.

Thus, the rotary lever hole 101 of the barrel 100 extends to the middle portion of the rotary lever hole 203 of the cartridge 200, and a surface of the screw lever 300 is exposed through the rotary lever hole 101.

When the second end of the screw lever 300 is pushed by the hand to change the above state into the open state of FIGS. 10 to 13, the locking protrusion 201 is bent inwards to be removed from the second locking hole 104, and the piston 400 integrally coupled to the screw lever 300 and the cartridge 200 move forwards towards the nozzle 500, so that the spring 50 is compressed.

As the screw lever 300 continues to move forwards, the locking protrusion 201 of the cartridge 200 which moves forwards along the guide hole restraining the guide protrusion is restrained by the first locking hole 103, so that the screw lever 300 stops moving forwards.

Thereby, until the cartridge 200 is removed from the second locking hole 104 and then restrained by the first locking hole 103, the anti-drying unit performs an opening operation, so that the ball-type door 90 is rotated 90°, and thus the nozzle hole of the barrel 100 is opened by the ball-type door 90 and the nozzle 500 is ejected out of the open nozzle hole because of the forward movement of the cartridge 200.

Simultaneously, because of the forward movement of the cartridge 200, the rotary lever hole 101 of the barrel 100 is aligned with the rotary lever hole 203 of the cartridge 200, so that the exposed area of the screw lever 300 reaches a maximum.

If the screw lever 300 is rotated in one direction in order to discharge the contents from the ejected nozzle 500, the piston 400 fastened to the screw lever 300 in a threaded manner moves forwards along the internal thread of the screw lever 300. Thereby, the contents filled in the tank part 243 of the cartridge 200 are pushed by the forward movement of the piston 400, so that the contents are discharged through the contents moving part and the connection part 244 to the nozzle 500.

When a required amount of contents is discharged and then the return switch 102 of the barrel 100 is pushed so that the nozzle 500 is retracted into the barrel 100, the locking protrusion 201 of the cartridge 200 on which the push pressure of the return switch 102 acts is bent inwards again and is removed from the second locking hole 104. Thereby, the cartridge 200, the piston 400, and the screw lever 300 are integrally moved backwards by the restoring force of the compressed spring 50.

The closing operation of the anti-drying unit is performed until the cartridge 200 is removed from the first locking hole 103 and then is restrained by the second locking hole 104 again, so that the ball-type door 90 is rotated 90° and thus the nozzle hole of the barrel 100 is closed by the ball-type door 90 and the nozzle 500 is retracted into the nozzle hole which is closed by the backward movement of the cartridge 200.

As described above, the present invention provides a one-touch-type gel container having an automatic sealing structure, which includes an anti-drying unit to prevent cosmetic ingredients from being in contact with the outside air to the maximum extent possible, thus allowing the cosmetic ingredients to be preserved for a longer period of time and minimizing the volatilization of the cosmetic ingredients.

Further, the present invention provides a one-touch-type gel container having an automatic sealing structure, which can prevent liquid ingredients in a nozzle from drying even if an additional cap is not used, can physically safely protect the nozzle, and makes it convenient to use.

Furthermore, the present invention provides a one-touch-type gel container having an automatic sealing structure, which is constructed so that a predetermined amount of liquid ingredients is pushed and discharged by a piston of a cartridge, thus allowing a desired amount of liquid ingredients to be used, therefore preventing cosmetics from being wasted.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A one-touch-type gel container having an automatic sealing structure, comprising:
a barrel comprising an integrated casing having a shape of a hollow pipe, and comprising:
a nozzle hole formed in a first conical end of the barrel to permit a nozzle to be ejected or retracted; and
an insert hole formed in a second end of the barrel;
a cartridge inserted into the barrel, and moving forwards and backwards in a longitudinal direction of the barrel;
a screw lever having a shape of a pipe which is open at an end, the screw lever being restrained at an end thereof by a step of a tank part of the cartridge to be rotated without forward or backward movement in the tank part;
a piston accommodated in the screw lever, a first end of the piston being connected to a contents moving part which has a diameter that is set to be accommodated in the cartridge, a second end of the piston having a shape corresponding to the screw lever to engage with an inner wall of the screw lever; and
an anti-drying unit interposed between the cartridge and the barrel to air-tightly close the nozzle hole of the barrel in conjunction with forward or backward movement of the cartridge which is moved integrally with the screw lever.

2. The one-touch-type gel container as set forth in claim 1, wherein the barrel comprises a first and a second locking holes arranged in a longitudinal direction on a side of an elliptical rotary lever hole which is formed adjacent to the second end of the barrel, and the cartridge comprises a locking protrusion protruding from a side surface of the tank part to be removably restrained by the first or second locking hole, and a rotary lever hole formed on a side of the locking protrusion to have the same shape and position as the rotary lever hole of the barrel.

3. The one-touch-type gel container as set forth in claim 2, wherein the locking protrusion is formed on a sidewall of the cartridge in the form of an elastic free end such that the locking protrusion can be easily removably restrained by the first locking hole or by the second locking hole.

4. The one-touch-type gel container as set forth in claim 3, wherein the barrel further comprises:
a return switch extending from a location in front of the first locking hole in the form of a free end so as to allow the locking protrusion to be easily removed from the first locking hole, the return switch when pushed by a hand being bent into the barrel to make the locking protrusion restrained by the first locking hole be bent into the cartridge, thus removing the locking protrusion from the first locking hole.

5. The one-touch-type gel container as set forth in claim 4, wherein the return switch has a protruding push part so that the return switch can be easily pushed.

6. The one-touch-type gel container as set forth in claim 1, wherein a guide protrusion having a form of a free end is formed at a position opposite to the locking protrusion of the cartridge, and the barrel comprises a guide hole at a position corresponding to the guide protrusion so that the guide protrusion is inserted into and restrained by the guide hole, thus guiding the cartridge to perform rectilinear movement when the cartridge moves forwards and backwards in the longitudinal direction of the barrel.

7. The one-touch-type gel container as set forth in claim 6, wherein the cartridge comprises a tension groove to define a space to permit the free end to be bent into the cartridge.

8. The one-touch-type gel container as set forth in claim 1, wherein the cartridge comprises:
a tank part having a largest diameter, a first portion of the tank part receiving contents and a second portion thereof receiving the screw lever;
a connection part having a diameter smaller than that of the tank part, a first portion of the connection part receiving the contents and a second portion thereof receiving the contents moving part; and
an extension part having a diameter smaller than that of the connection part, and firmly coupled at an end thereof to the nozzle.

9. The one-touch-type gel container as set forth in claim 1, wherein an 0-ring is provided at a junction between the piston and the contents moving part in such a way as to be in close contact with an inner wall of the cartridge, thus preventing contents from remaining in the cartridge when the piston moves forwards.

10. The one-touch-type gel container as set forth in claim 1, wherein the screw lever comprises at the second end thereof an air circulating hole to permit flow of air in a space defined by movement of the piston.

11. The one-touch-type gel container as set forth in claim 8, wherein a groove formed on an inner wall of the connection part in the longitudinal direction of the barrel engages with a cross-shaped step of the contents moving part, and an internal thread formed on the inner wall of the screw lever engages with an external thread formed on the piston, so that the piston conducts only rectilinear movement when the screw lever is rotated.

12. The one-touch-type gel container as set forth in claim 8, wherein an internal thread formed on an inner wall of the connection part engages with an external thread formed on the contents moving part, and a rib provided on the inner wall of the screw lever in a longitudinal direction thereof engages with a rib provided on the piston in a longitudinal direction thereof, so that the piston conducts rectilinear movement and rotation when the screw lever is rotated.
